(19) United States
(12) Patent Application Publication
(10) Pub. No.: US 2024/0221182 A1
(43) Pub. Date: Jul. 4, 2024

(54) OBJECT TRACKING FOR SCAN SEQUENCE DETECTION

(71) Applicant: DATALOGIC USA, INC., Eugene, OR (US)

(72) Inventors: Filippo Mambelli, Los Angeles, CA (US); Kenneth Bradley, Cypress, CA (US)

(21) Appl. No.: 18/090,986

(22) Filed: Dec. 29, 2022

(51) Int. Cl. G06T 7/215; G06T 3/40; G06T 5/00; G06T 5/50; G06T 7/194; G06V 10/98

(52) U.S. Cl. CPC G06T 7/215; G06T 3/4084; G06T 5/002; G06T 5/50; G06T 7/194; G06V 10/98; G06T 2200/24; G06T 2207/10016; G06T 2207/20048; G06T 2207/20081; G06T 2207/20221

(57) ABSTRACT

Assessment of movement of an object in a scanning volume may assist a symbol-reading system to assess success of a symbol-reading attempt. For each captured image frame, a transform to a frequency-spatial representation of that image frame is computed, and background is reduced based on a trained statistical model of a background of the scanning volume to produce a foreground mask representing the object. A motion vector representing motion of the object from the at least one prior image frame to the current image frame is computed. In response to an assessed extent of motion, sequence scanning is performed, including storing the motion vector corresponding to the current image frame as part of a sequence that includes a plurality of motion vectors corresponding to a plurality of image frames, where the sequence collectively characterizes motion of the object in the scanning volume over the plurality of image frames.

### TECHNICAL FIELD

The present disclosure generally relates to machine vision and, more particularly, to tracking the movement of objects in a scan volume.

### BACKGROUND

Symbol-reading technology has evolved from linear readers, such as laser barcode scanners, to 2D imagers, which capture image frames and perform processing to detect and decode any symbols present in the captured images. 2D imagers offer a number of advantages, including the ability to read different types of symbols, including traditional barcodes, 2D symbols, such as data matrix symbols, printed strings of one or more characters or numerals, handwriting, or the like.

Applications of symbol-reading technology are far-reaching. Perhaps the most familiar application is in retail point-of-sale systems, where machine-readable symbols on goods are scanned to quickly identify each sellable unit. A typical point-of-sale system includes a fixed scanner that reads symbols affixed to each object being sold. At checkout, cashiers move items of goods, one at a time, past a symbol reader, making sure to place the symbol within the scan volume to be read. An audible tone or bleep indicates whether a symbol was scanned correctly. Failure to complete a scan of an item's symbol results in loss to the retailer. Inadvertent duplicative scanning of an item results in overcharging of the customer. Care must be taken by the cashier to minimize such mistakes.

Retailers are increasingly deploying self-service kiosks that are usable by customers to self-checkout their own purchases. Such kiosks generally function as conventional cashier-operated systems, except that additional provisions are often included to detect and flag any irregularities, such as failed scans. Typical provisions include a scale in the bagging area that receives scanned (and non-scanned) items and compares any changes in measured weight against known weights of the individually-scanned items. Customers are notified of detected irregularities, and prompted to make correction, such as re-scanning the most recently-scanned item, or removal of an item scanned twice in error from the purchased-item list. In practice, such kiosks are imperfect and tend to be overly-sensitive, erring on the side of flagging suspected irregularities when, in fact, the customer may have scanned and placed an item in the bagging area correctly. Customers may have difficulty resolving flagged irregularities, leading them to call a retail staff member for support. On the whole, the throughput of self-service kiosks is far less than what would be possible with more accurate scanning.

Solutions are needed to address these, and related, challenges in retail scanning systems. Similar improvements are needed in other applications of symbol-reading technology in which fixed scanners are used, such as inventory-tracking applications, transportation and logistics applications, and others.

### SUMMARY

According to some aspects of this disclosure, assessment of movement of an object in a scanning volume may assist a symbol-reading system to assess success of a symbol-reading attempt. For each captured image frame, a transform to a frequency-spatial representation of that image frame is computed, and background is reduced based on a trained statistical model of a background of the scanning volume to produce a foreground mask representing the object. A motion vector representing motion of the object from the at least one prior image frame to the current image frame is computed. In response to an assessed extent of motion, sequence scanning is performed, including storing the motion vector corresponding to the current image frame as part of a sequence that includes a plurality of motion vectors corresponding to a plurality of image frames, where the sequence collectively characterizes motion of the object in the scanning volume over the plurality of image frames.

One aspect is directed to is a motion tracking system for processing a series of captured image frames to assess movement of an object in a scanning volume and providing an output to a symbol-reading system. The motion tracking system includes an input to receive the series of captured image frames of the scanning volume; an object detection engine operatively coupled to the input to perform first autonomous processing of the captured image frames. The first autonomous processing includes: for each image frame, computation of a transform to a frequency-spatial representation of that image frame; and computation of a background reduction of the frequency-spatial representation based on a trained statistical model of a background of the scanning volume to produce a foreground mask representing the object.

A motion tracking engine is operatively coupled to the object detection engine to perform second autonomous processing of the foreground mask. The second autonomous processing includes: computation of a motion vector representing motion of the object from the at least one prior image frame to the current image frame; application of object tracking criteria to the motion vector to assess an extent of motion of the object in the scanning volume; in response to the extent of motion in the scanning volume, performance of the sequence scanning, including storage of the motion vector corresponding to the current image frame as part of a sequence that includes a plurality of motion vectors corresponding to a plurality of image frames. The sequence collectively characterizes motion of the object in the scanning volume over the plurality of image frames. An output is operatively coupled to the motion tracking engine and to a symbol-reading system, the output may indicate characteristics of movement of the object in the scanning volume, where the output, in combination with a symbol reading result, is indicative of a failed symbol-reading attempt.

The system may be incorporated as part of a symbol reading system, object detection system, and myriad others.

In another aspect, an automated method is provided for assessing movement of an object in a scanning volume and providing an output to a symbol-reading system to assess success of a symbol-reading attempt. The method includes receiving a series of captured image frames of the scanning volume. For each image frame, a transform to a frequency-spatial representation of that image frame is computed. A background reduction of the frequency-spatial representation based on a trained statistical model of a background of the scanning volume is computed to produce a foreground mask representing the object. Further, a motion vector representing motion of the object from the at least one prior image frame to the current image frame is computed. Object tracking criteria is applied to the motion vector to assess an extent of motion of the object in the scanning volume. In response to the extent of motion in the scanning volume, sequence scanning is performed, including storing the motion vector corresponding to the current image frame as part of a sequence that includes, a plurality of motion vectors corresponding to a plurality of image frames. The sequence collectively characterizes motion of the object in the scanning volume over the plurality of image frames.

An output may be provided to a symbol-reading system to indicate characteristics of movement of the object in the scanning volume, wherein the output, in combination with a symbol reading result, is indicative of a failed symbol-reading attempt.

### BRIEF DESCRIPTION OF THE DRAWINGS

FIG. 1 is a simplified diagram illustrating a scanning system as it may be employed in a basic usage scenario, according to some embodiments.

FIG. 2 is a high-level block diagram illustrating an example system architecture of the scanning system of FIG. 1, with some components of scanning controller shown.

FIG. 3 is a simplified block diagram illustrating a portion of processing hardware of a scanning controller according to an example embodiment.

FIG. 4 is a high-level functional architecture diagram illustrating some of the engines of a scanning controller according to an example embodiment.

FIG. 5 is a structural diagram illustrating a supervisory engine according to an example embodiment.

FIG. 6 is a structural diagram illustrating an object detection engine according to an example embodiment.

FIG. 7 is a structural diagram illustrating a motion tracking engine according to an example embodiment.

FIGS. 8-9 are flow diagrams illustrating operations that may be performed by an object detection engine in greater detail, according to some embodiments.

FIG. 10 is a flow diagram illustrating a motion-tracking process which may be carried out by motion tracking engine according to an example.

FIG. 11 is a flow diagram illustrating an example set of operations of a phase correlation process according to an embodiment.

FIG. 12 is a state-machine diagram of various states and conditions for changing states according to an embodiment of scanning system.

FIG. 13 is a timing diagram illustrating a basic example of operational iterations through the state machine of FIG. 12 that results in a starting and stopping of a scan sequence.

FIG. 14 is a timing diagram illustrating usage of background-reduction models for computation of the foreground masks in an object detection operation according to some embodiments.

FIG. 15 is a timing diagram illustrating an example case where a scan sequence is started normally, but is terminated when the object becomes still for some period of time.

FIG. 16 is a timing diagram illustrating an example use case where a scanning sequence is not started for lack of movement in the scanning volume.

FIG. 17 is a structural diagram illustrating an image stitching engine according to an example embodiment.

FIG. 18 is a diagram illustrating an example ordering in which the images are composed in the final composite image in relation to the original ordering of the sequence, with the frame on top representing the one selected as the main frame.

FIG. 19 shows a definition of a 1D Tukey function.

FIG. 20 is a graphical illustration of a Tukey window with α=0.3.

FIGS. 21A and 21B illustrate an example of a composite image, before and after Tukey blending, respectively.

FIG. 22 shows a series of images as inputs to an image-stitching process, each of which contains only a portion of an object, as well as a composite image as the output of the image stitching operations, according to an example use case.

### DETAILED DESCRIPTION

The illustrations included herewith are not meant to be actual views of any particular systems, memory device, architecture, or process, but are merely idealized representations that are employed to describe embodiments herein. Elements and features common between figures may retain the same numerical designation except that, for ease of following the description, for the most part, reference numerals begin with the number of the drawing on which the elements are introduced or most fully described. In addition, the elements illustrated in the figures are schematic in nature, and many details regarding the physical layout and construction of a memory array and/or all steps necessary to access data may not be described as they would be understood by those of ordinary skill in the art.

As used herein, the singular forms “a.” “an,” and “the” are intended to include the plural forms as well, unless the context clearly indicates otherwise.

As used herein, “or” includes any and all combinations of one or more of the associated listed items in both, the conjunctive and disjunctive senses. Any intended descriptions of the “exclusive-or” relationship will be specifically called out.

As used herein, the term “configured” refers to a structural arrangement such as size, shape, material composition, physical construction, logical construction (e.g., programming, operational parameter setting) or other operative arrangement of at least one structure and at least one apparatus facilitating the operation thereof in a defined way (e.g., to carry out a specific function or set of functions).

As used herein, the phrases “coupled to” or “coupled with” refer to structures operatively connected with each other, such as connected through a direct connection or through an indirect connection (e.g., via another structure or component).

Aspects of the present disclosure are directed to symbol-reading systems that are specifically designed to scan objects which are moved through a scanning volume. In the present context, scanning of an object includes reading one or more symbols that are on the object.

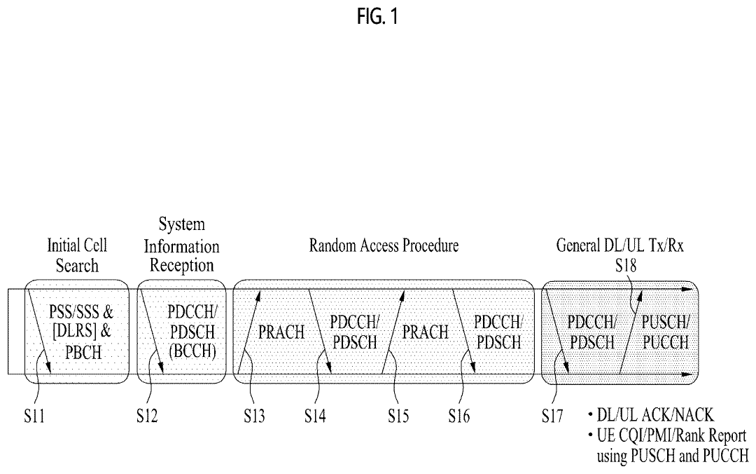

FIG. 1 is a simplified diagram illustrating scanning system 100, as it may be employed in a basic usage scenario, according to some embodiments. System 100 includes image-capture device 102, which may be implemented as a camera with an image sensor, objective lens, aperture, housing, etc. Image capture device 102 is arranged to capture image frames of scanning volume 110. The image sensor according to various implementations may include an array of photosensing elements. Examples of photosensing elements include complementary metal-oxide semiconductor (CMOS) sensors, charge-coupled devices (CCDs), and the like. The image sensor may be constructed using any suitable technology, whether known or arising in the future. Without limitation, some other examples include a high-dynamic-range (HDR) sensor array, a hyperspectral sensor array, a polarized sensor array, or the like.

In some implementations, scanning system 100 includes illumination system 112, which is arranged to illuminate scanning volume 110. Illumination system 112 may include an array of light-emitting diodes that produce light in suitable wavelength(s). The wavelength(s) may be in the visible-light spectrum, or in the infrared or ultraviolet spectra, and may include wavelengths falling into one or more of these bands. Other light sources, such as incandescent or discharge lamps are also contemplated.

In some implementations, additional sensing inputs are provided to scanning controller 120. For instance, load cell 114, which is arranged to detect the weight of items placed in a post-scan area (e.g., of a self-checkout station), may be provided. In some embodiments, the load cell 114 may be incorporated within a fixed retail scanner (e.g., a single plane scanner, a multi-plane scanner, etc.) installed in a checkout area (e.g., a self-checkout station, an assisted checkout lane, etc.). In other related implementations, one or more additional image-capture devices (not shown) may be provided to facilitate stereoscopic vision, improved object detection and tracking accuracy, ambient-condition sensing, scanning volume enlargement, improved vision of machine-readable symbols from additional perspective(s), or other use.

Image-capture device 102, illumination system 112, and load cell 114 or other input, are each operatively coupled to scanning controller 120, which controls their operation and processes the captured images to detect object 106, analyze its motion through scanning volume 110, and read symbol 107 or determine whether the reading of a symbol was unsuccessful. In some embodiments, Image-capture device 102, illumination system 112, and load cell 114 or other input(s) may be operatively coupled to scanning controller 120 through a suitable local interface (e.g., USB, Ethernet, etc.) or may be integrated with the image processor system and interconnected using one, or a combination of, internal interconnect(s) such as a suitable variant of a peripheral component interconnect (PCI), serial AT Attachment (SATA), mobile industry processor interface (MIPI), or other interconnect(s) known by those skilled in the art. In some implementations, as depicted, scanning controller 120 may be operatively coupled to a sales or transaction system 122 or an inventory system 124 through a network 114 (e.g., LAN, WAN, PAN, Internet).

In the usage scenario depicted, object 106, which has machine-readable symbol 107 is moved through scanning volume 110 to be scanned. Object 106 may be moved manually by operator 130 or, in other applications, by an automated conveyance system, such as vehicle, robotic arm, crane, elevator, conveyor belt, turntable, blower, or the like. The automated conveyance system may be powered or unpowered (e.g., gravity-based).

Notably, scanning system 100 includes features, detailed below, which advantageously facilitate discriminating object 106 from other objects or structures in the background, and autonomously determining whether object 106 is moved through scanning volume 110 in a manner that is likely to be an attempt at presenting symbol 107 for reading by system 100. Accordingly, system 100 can assess whether a scanning attempt was successful or unsuccessful. Likewise, system 100 is able to reduce or prevent unintended duplicative scanning of object 106 (e.g., double read), as may occur in the case of irregular movement patterns.

In another aspect, scanning system 100 is constructed, programmed, or otherwise operative, to reconstruct the image of a complete object given a sequence of images where each image contains a partial view of the object as it moves across a scanning volume such as a product scanning sequence captured by a camera of a scanner or a parcel moving on a conveyor belt underneath a fixed camera. The system can perform image stitching to compose one image that represents the whole item shown in a sequence, using small computational resources per frame.

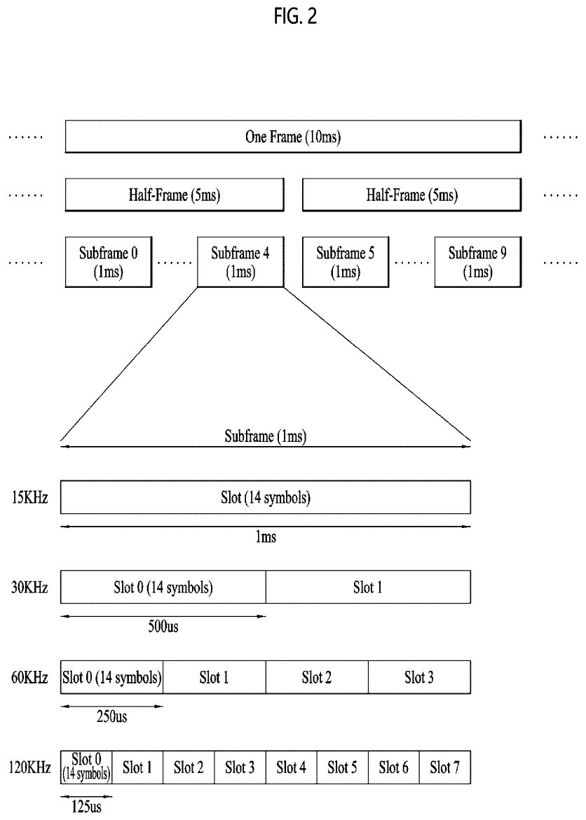

FIG. 2 is a high-level block diagram illustrating an example system architecture of scanning system 100, with some components of scanning controller 120 shown. Scanning controller 120 includes processing hardware 202 operatively coupled to image-capture device interface 204, input-device interface 208, operator interface 210, data interface 214, and illumination system interface 206. Processing hardware 202 includes one or more processor circuits that execute software or firmware instructions 203, which instructions are stored in a non-transitory machine-readable medium such as a read-only memory, flash memory, random-access memory, or the like.

Image-capture device interface 204 includes circuitry facilitating the exchange of data between processing hardware 202 and image-capture device 102. In some examples, image-capture device interface 204 includes data buffers, video decoders, video encoders, address and data bus interfaces, serial data receiver/transmitter circuitry, analog-to-digital (A/D) converter circuitry, and the like. The data communications portions of image-capture device interface 204 may facilitate wired or wireless communication. Image-capture device interface 204 is operative to pass its output (e.g., activated pixels, images, video frames) from their original format as output by image-capture device 102 to processing hardware 202 in a suitable data format to be read by processing hardware 202. In a related example, image-capture device interface 204 may additionally be configured to pass information from processing hardware 202 to image-capture device 102. This upstream information may include configuration commands such as sensor gain settings, frame rate, exposure control, activation/deactivation commands, etc.

In some embodiments, image-capture device interface 204 may be integrated as part of a digital signal processor (DSP) device or microcontroller device. In other embodiments, mage-capture device interface 204 may be integrated as part of one or more image-capture devices 102.

Illumination system interface 206 includes circuitry to control the operation of individual ones, or groups, of the photo emitters of illumination system 106. Illumination system interface 206 may include current regulator circuitry, switching circuitry, or the like.

Input device interface 208 includes circuitry to interface with load cell 114 or other input device. Examples of other input devices include sensors, such as a ranging sensor, motion sensor, thermometer, humidity sensor, precipitation sensor, smoke/particulate sensor etc.

Operator interface 210 includes user-operable controls, such as pushbuttons, keypad, touchscreen, and the like, as well as a display or indicators such as a liquid-crystal display (LCD), LED indicators, speaker or buzzer, and other suitable output devices.

Data interface circuitry 214 includes wired or wireless communications facilities that provide input and output to and from processing hardware 202. Sale or transaction system 122, inventory system 124, or other external device or system may be operatively coupled to scanning controller 120 via data interface circuitry 214. Data interface circuitry 214 may include one or more of the following types of communication circuits: universal serial bus (USB), CAN, I²C, SPI, UART, I²C, Ethernet, personal-area network such as Bluetooth according to an IEEE 802.15 standard, Wi-Fi according to an IEEE 802.11 standard, or the like.

Other data reader configurations may be used without departing from the principles of the disclosed subject matter. Examples of various data reader configurations include U.S. Pat. No. 8,430,318, issued Apr. 30, 2013, and entitled “SYSTEM AND METHOD FOR DATA READING WITH LOW PROFILE ARRANGEMENT.” U.S. Pat. No. 9,004,359, issued Apr. 14, 2015, entitled “OPTICAL SCANNER WITH TOP DOWN READER,” U.S. Pat. No. 9,305,198, issued Apr. 5, 2016, entitled “IMAGING READER WITH IMPROVED ILLUMINATION,” U.S. Pat. No. 10,049,247, issued Aug. 14, 2018, entitled “OPTIMIZATION OF IMAGE FRAME MANAGEMENT IN A SWEEP-STYLE OPTICAL CODE DATA READER,” U.S. Pat. No. 10,248,896, issued Apr. 2, 2019, and entitled “DISTRIBUTED CAMERA MODULES SERIALLY COUPLED TO COMMON PREPROCESSING RESOURCES FACILITATING CONFIGURABLE OPTICAL CODE READER PLATFORM FOR APPLICATION-SPECIFIC SCALABILITY,” and U.S. Patent Application Publication No. 2020/0125812, filed Dec. 2, 2019, and entitled “DATA COLLECTION SYSTEMS AND METHODS TO CAPTURE IMAGES OF AND DECODE INFORMATION FROM MACHINE-READABLE SYMBOLS,” and U.S. patent application Ser. No. 18/071,594, filed Nov. 29, 2022, and entitled “FIXED RETAIL SCANNER WITH MULTI-PORT NETWORK SWITCH AND RELATED METHODS, the disclosure of each of which is incorporated by reference herein in its entirety.

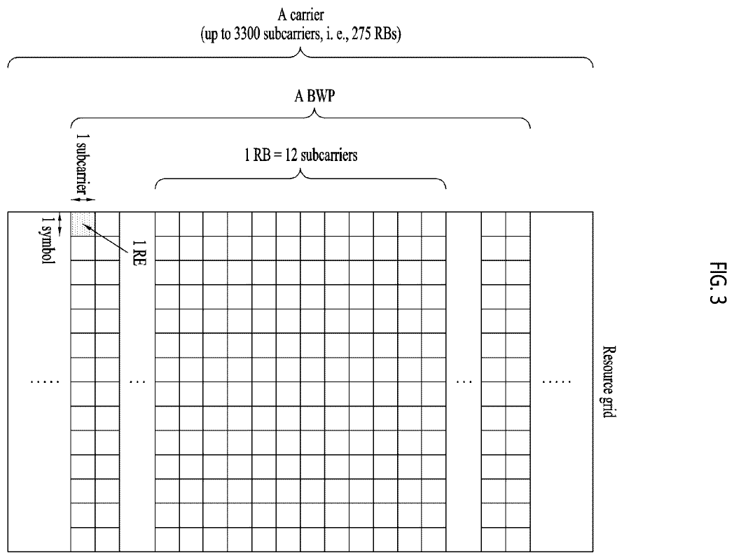

FIG. 3 is a simplified block diagram illustrating a portion of processing hardware 202 of scanning controller 120 according to one example. Processing hardware 202 includes instruction processor 310, video processor 312, and input/output (I/O) controller 314. Instruction processor 310 is constructed to execute software or firmware instructions 203, the execution of which causes instruction processor 310 to implement engines (defined below) to carry out the overall functionality of scanning system 100 in conjunction with the other components of scanning controller 120, image capture device 102, illumination system 112, and load cell 114 or other input, as shown in FIG. 1. For instance, instruction processor 310 may read input device interface 208 and take actions in response to those inputs; instruction processor 310 may write output to operator interface 210; and instruction processor 310 may exchange data with data interface circuitry 214 to send and receive data to or from other devices or systems. In addition, instructions 203, when executed by instruction processor 310, may cause instruction processor 310 to carry out object detection, movement tracking, training, decision logic, and symbol reading operations, as well as other functionality, to operatively implement scanning system 100.

Instruction processor 310 may be of any suitable architecture. As an example, instruction processor 310 may include a central processing unit (CPU) core, RAM, non-volatile memory, memory controllers, address and data (or shared) busses, serial communications ports such a universal synchronous receiver/transmitter (UART), and peripheral circuitry such as timers, event counters, A/D or D/A converters, pulse-width modulation (PWM) generator, etc.

Video processor 312 is interfaced with instruction processor 310, and implements engines to receive captured images from image capture device 102, and to resample, crop, compress, or combine portions of images, filter, remove background, assess the size of a detected object, track motion of a detected object, and perform symbol reading algorithms, where applicable. In some embodiments, video processor 312 includes a digital signal processor (DSP) core having a computing architecture that is optimized for video processing and including additional or specialized arithmetic logic units (ALUs)—direct-memory access, fixed-point arithmetic, etc., ASIC. FPGA, CPLD, or combination thereof.

I/O controller 314 includes circuitry that facilitates addressing, data transfer, memory access, and other interactions between instruction processor 310, video processor 312, and the other components of scanning controller 120. As examples, I/O controller 314 may include a bus or system interconnect controller, a serial communications hub controller, or the like.

In related embodiments, instruction processor 310 and video processor 312 are integrated as a single processing device, such as a digital signal controller (DSC) that is configured to perform the respective functionality of instruction processor 310 and video processor 312 described above. Similarly, I/O controller 314 may also be integrated as part of a DSC implementation. In other related embodiments, some portion of processing hardware 202 may be implemented with logic circuitry 316, such as an application-specific integrated circuit (ASIC), FPGA, CPLD, hardware coprocessor, or the like. Logic circuitry 316 may be utilized to perform certain operations with greater speed or power efficiency than can be conventionally achieved using an instruction processor, such as S-transform computation, phase correlation operations, or the like.

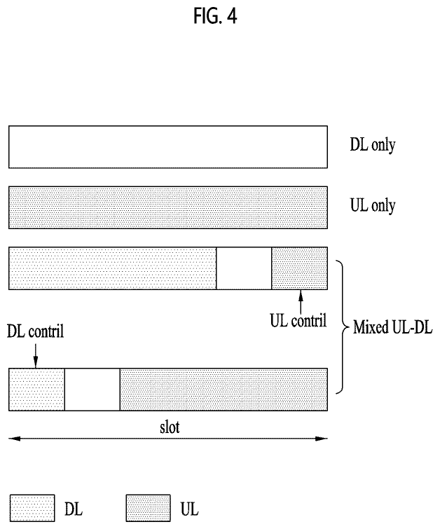

Scanning controller 120 implements various engines, each of which is constructed, programmed, or otherwise operative, to carry out a function or set of functions, as detailed below. FIG. 4 is a high-level functional architecture diagram illustrating some of the engines of scanning controller 120 according to an example embodiment. In this example, scanning controller 120 includes object detection engine 402, motion tracking engine 404, training engine 406, illumination control engine 408, scan engine 410, symbol reader engine 410, data store 418, image stitching engine 414, and supervisory engine 420.

The term “engine” as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible, non-transitory, machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is specifically configured (e.g., hardwired), or temporarily configured (e.g., programmed) to operate in a specified manner or to perform part or all of any operations described herein in connection with that engine.

In examples in which engines are temporarily configured, each of the engines may be instantiated at different moments in time. For example, where the engines comprise a general-purpose hardware processor core configured using software; the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Object detection engine 402 is constructed, programmed, or otherwise operative, to process each captured image frame to assess whether an object, such as object 106, which is distinct from the background of scan volume 110, is present. Detection of an object is a prerequisite to attempting to track any motion of that object. Motion tracking engine 404 is constructed, programmed, or otherwise operative, to identify the direction and the magnitude of the translation vector of the object as it moves within the scanning volume.

Training engine 406, which is optional in some embodiments, is constructed, programmed, or otherwise operative, to train object detection engine 402 to better discriminate objects from the background based on the activity state of object detection engine 402. For example, different background-suppression models may be used in an idle state when no moving object is detected, and in an active state when a moving object may be tracked. Likewise different lighting conditions may be used (e.g., illumination on/off) depending on the activity state of object detection engine 402, further calling for the use of different background-suppression models. Various training schemes may be employed to accommodate potentially changing conditions, such as ambient lighting, and the appearance of objects which are not of interest for scanning purposes.

Illumination control engine 408, which is optional in some embodiments, is constructed, programmed, or otherwise operative, to activate illumination system 112, when such a system is available. For instance, illumination of scanning volume 110 may be activated when a potential object is detected in order to improve the image quality during motion tracking and symbol reading. The illumination may be deactivated in the absence of a potential object to reduce operator fatigue and conserve energy. The illumination may also serve a notification function of confirming for the operator that scanning system 110 has detected an object in the scanning volume.

Symbol reader engine 410 is constructed, programmed, or otherwise operative, to locate and read machine-readable symbol(s) that are on the object. Any suitable image-processing algorithm may be utilized by symbol reader engine 410 such as, for instance, the techniques described in U.S. Pat. No. 9,361,503, the disclosure of which is incorporated by reference herein.

Image stitching engine 414 is constructed, programmed, or otherwise operative, to stich partial images taken of an object moving in the scanning volume based on the computed motion vectors. Image stitching engine composes, in a single image, all the portions of the images that contain the object and rearrange them to reconstruct an image of the object, as well as to minimize, to the extent possible, the impact of seams (defined as the regions of the juxtaposition of different images) on the object or around a specific region of the object. For example, using knowledge of which frames a readable symbol or label is present, image stitching engine 414 avoid creating an artifact across that element on the final composite image.

Supervisory engine 420 is operatively interfaced with the other engines as depicted, and is constructed, programmed, or otherwise operative, to coordinate their conditional operations and sequencing. Supervisory engine 420 may also apply decision logic to selectively call certain engines. For example, supervisory engine 420 may call motion tracking engine in response to an output of object detection engine 402 meeting certain criteria, such as detected object size or duration.

Data store 418 maintains adjustable parameters or constants for use with algorithms executed by engines 402-410 and 420. Such parameters or constants may be user-configurable in some implementations. In related implementations, such parameters may be adaptively adjusted by the algorithms themselves, such as being adjusted by optimizing algorithms, training algorithms, or the like. In the latter example, training data or models may be maintained in data store 418.

Although the engines depicted in FIG. 4 may be implemented as distinct functional blocks, it should be understood that the various functionality of certain engines may be implemented, in whole or in part, as a subset of one or more of the other engines. For example, the coordination, sequencing, or decision logic of supervisory engine 420 may be distributed among the functionality of the other engines. Likewise, the functionality of illumination control engine 408 may be implemented as part of object detection engine 402. Training engine 406 and motion tracking engine 404 each may share certain functionality with object detection engine 402. Further, certain processing facilities, such as transform-space processing, may be shared among various engines. For example, symbol reader engine 410 may employ a transformation engine, such as an S-transform engine, which may be utilized by object detection engine 402, and motion tracking engine 404, and image stitching engine 414.

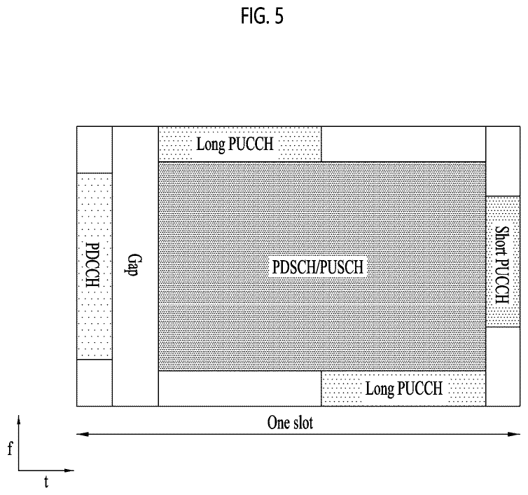

FIG. 5 is a structural diagram illustrating supervisory engine 420 according to an example embodiment. As depicted, supervisory engine 420 includes processing hardware 200, and instructions 502 stored on one or more non-transitory storage media and executable by computing hardware 200 to implement supervisory engine 420 according to this example. Instructions 502, when executed, cause the computing hardware 200 to implement the following process, which may be performed with different orderings of operations unless certain operations are specifically called out as being performed in sequence. In some variations, certain operations may be modified or omitted.

At 512, supervisory engine 420 receives the next image frame via image capture interface 204 (FIG. 2) as captured by image capture device 102. For each image frame, supervisory engine 420 performs operations 514-528. At 514, supervisory engine 420 calls object detection engine 402 to test for the presence of an object, such as object 106, in scan volume 110. At 516, if the output of object detection engine 402 meets object-detection criteria, supervisory engine 420 calls motion tracking engine 404 at 518 to measure the motion of the object. As will be described in greater detail below, the object-detection criteria may include size criteria, temporal criteria, or some combination thereof. If the object-detection criteria is not met at decision 516, supervisory engine 420 loops back to 512 to read the next image frame. In embodiments that employ training, at 520, object detection engine 402 may be trained in its idle state (e.g., illumination off).

At 522, supervisory engine 420 tests if the output of motion tracking engine 404, namely, the magnitude of the motion vector, meets certain movement criteria. At 524, if the movement criteria is met, supervisory engine 420 advances to 526 to record the scan sequence. The scan sequence in this context refers to a set of motion vectors representing, frame-by-frame, the motion of the object in the scanning volume. In embodiments that employ training, the motion-tracking state (e.g., illumination on) may be trained at 528 by calling training engine 406. In some embodiments, during recording of the scan sequence, supervisory engine 420 may call symbol reader engine 410 to read the machine-readable symbol(s) on the object, and assess if there has been a failed attempt to read the symbol(s), as indicated at 530.

In one embodiment, failure of the symbol reading attempt is determined by supervisory engine 420 based on a scan sequence indicative of an attempted read, and an absence of a successful reading of any symbol during that scan sequence.

In a related embodiment, supervisory engine 420 may call image stitching engine 414 at 532 to stitch together images of portions of the object to create a composite image for further processing.

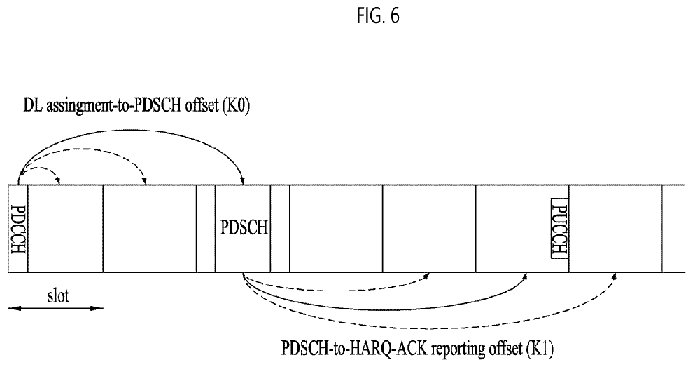

FIG. 6 is a structural diagram illustrating object detection engine 402 according to an example embodiment. As depicted, object detection engine 402 includes processing hardware 200, and instructions 602 stored on one or more non-transitory storage media and executable by computing hardware 200 to implement object detection engine 402 according to this example. Instructions 602, when executed, cause the computing hardware 200 to implement the following process, which may be performed with different orderings of operations unless certain operations are specifically called out as being performed in sequence. In some variations, certain operations may be modified or omitted.

At 612, object detection engine 402 reads the next captured image frame, which was passed to it via supervisory engine 420. Operations 614-630 are performed on the red image frame. At 614, object detection engine 402 computes a transform of the image frame to a frequency-spatial representation, such as an S-transform, for example. At 616, the S-transform output is downsampled. For instance, each n×m-pixel block of the image, such as each 16×16 block, may be given a single value. The resulting representation of the image frame includes frequency and spatial components of the image. In a related embodiment, the transformation and downsampling operations are combined as a single combined operation. At 618, the background is suppressed to determine whether an object is present. As an example, a background-subtraction algorithm based on a mixture-of-Gaussian model, such as the BackgroundSubtractorCNT algorithm, may be employed. The background subtraction is performed by applying a suitable statistical model of the intensity of the pixels in the background.

At 620, if no object is present, no further processing is necessary, and the operation of object detection engine 402 concludes until it is called once again to examine the next image frame. If an object is present, as determined at 620, object detection engine 402 assesses the size of the object in the foreground at 622. At 624, duration of the presence of the foreground object is assessed using one or more prior image frames, which were similarly processed.

At 626, size or duration criteria is applied to determine whether motion of the detected object should be tracked. The criteria may include one or more size thresholds that, if met, causes object detection engine 402 to initiate motion tracking, or end motion tracking. The criteria may also include combined size/duration thresholds such that if the foreground object of a certain size has a presence for a certain duration, motion tracking may be initiated. Accordingly, if the criteria is met at 628, motion tracking engine 404 may be authorized, as indicated at 630.

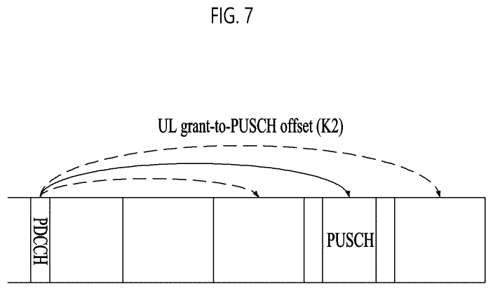

FIG. 7 is a structural diagram illustrating motion tracking engine 404 according to an example embodiment. As depicted, motion tracking engine 404 includes processing hardware 200, and instructions 702 stored on one or more non-transitory storage media and executable by computing hardware 200 to implement motion tracking engine 404 according to this example. Instructions 702, when executed, cause the computing hardware 200 to implement the following process, which may be performed with different orderings of operations unless certain operations are specifically called out as being performed in sequence. In some variations, certain operations may be modified or omitted.

When motion tracking engine 404 is called for each captured image frame in response to a detected object meeting motion-tracking criteria, the process flow of operations 712-734 is executed. At 712, a motion vector based on the S-transforms of the current image frame, and one or more prior image frames is computed. The motion vector represents a magnitude and direction of motion of the detected object. The motion vector may be computed using a phase correlation algorithm, as one example. The magnitude of the motion vector, along with duration of the motion, are determined at 714, and decision logic is applied to determine whether start or stop tracking motion. Accordingly, decision 716 determines if motion tracking is currently active. In the negative case, motion tracking is initiated at 720. If motion tracking is already active as per decision 716, decision 722 determines whether criteria for stopping the motion tracking is met. Motion-stopping criteria may include combined motion-vector magnitude and duration considerations. For instance, if the motion vector magnitude falls below a motion-tracking-stop threshold and remains so for a predefined number of image frames, the motion tracking may be stopped at 724. Likewise, motion-tracking-stopping criteria may include object size determination from object detection engine 402.

Motion tracking engine 404 may also implement criteria for recording a scan sequence, or motion of an object in the scan volume. Accordingly, at 726 motion tracking engine 404 determines if a scan sequence is already in progress. If no scanning is in progress, decision 728 determines whether scan-sequence-start criteria is met. For example, scan-sequence-start criteria may include motion vector magnitude exceeding a reading-start threshold. If such criteria is met, recording of the scan sequence is authorized to proceed at 730. If scanning is already in progress, decision 732 checks whether scan-stop criteria is met. Scan-stop criteria may include combined motion-vector magnitude and duration criteria. For example, if the motion vector magnitude falls below a stop threshold for a duration that exceeds a predetermined number of frames, the scan sequence recording may be concluded at 734.

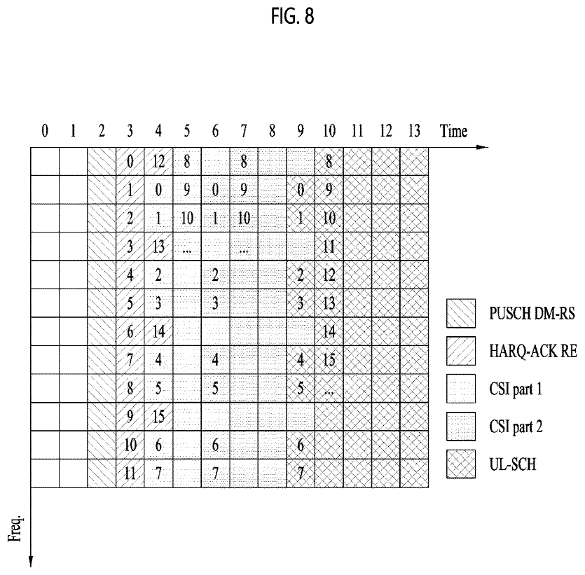

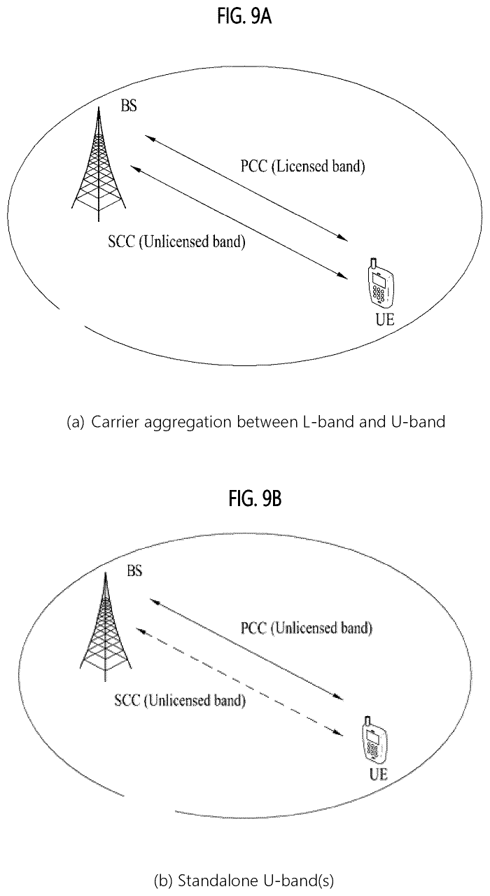

FIGS. 8-9 are flow diagrams illustrating operations that may be performed by object detection engine 402 in greater detail, according to some embodiments. FIG. 8 illustrates an example process 800 for performing initial detection of the presence of an object, such as object 106. These operations correspond generally to operations 612-622 (FIG. 6). At 802, object detection engine reads captured image frame 803 and passes it to an S-transform process 804. In some implementations, S-transform process 804 may be performed prior to, or independently from, other processing operations, such as via a hardware engine (e.g., FPGA) or using an optimized processor, such as a RISC processor (e.g., ARM) which executes a specialized processing library. In this way, the output of the S-transform operation 804 may be precomputed automatically on arrival of each incoming image frame; hence, the computation resources which carry out other operations of process 800 are not burdened with the S-transform computation. Advantageously, process 800, and the other processes may all run in real time on an embedded platform such as the one used in a fixed retail scanner, without compromising the performance of the symbol-reading operation.

S-transform operation 804 produces a set of outputs, which include the S-transform of image frame 803 along the X direction, S_{X} 805C, the S-transform of image frame 803 along the Y direction, S_{Y} 805D, and neighborhood maximum values, MAX 805A, and neighborhood minimum values, MIN 805B. For the MAX and MIN values, 805A and 805B, respectively, each neighborhood may be defined as an 8×8-pixel block or a 16×16-pixel block of image frame 803. Each output 805A-D of S-transform operation 804 may be treated as a distinct channel for further processing.

The MAX and MIN channels, 805A and 805B, are passed to background reduction operation 806. Each of these channels is applied against a corresponding trained model for background subtraction. The trained model is a statistical model of the intensity of the pixels in the background of scan volume 110. Application of the trained models produces channel-specific foreground masks. A final foreground mask 807 may be produced by a union of the two channels' foreground masks. In an embodiment that uses illumination, additional background models may be employed to account for the illumination-on and illumination-off conditions. Therefore in some embodiments, based on the current illumination state, an appropriate channel-specific, and illumination-state specific trained model for background reduction is used.

The output of the background reduction operation 806 is fed to decision 808, which applies initial criteria for determining if an object is potentially present in the foreground. In an example approach, the initial criteria is a size threshold for the foreground mask. In a related example, the initial criteria is a combination of foreground mask size, and duration (e.g., number of frames) that the foreground mask exceeds the size threshold.

In response to a positive indication of a possible object present at 808, illumination may be switched on at 810. In some implementations, the illumination may be used to assess proximity of the object to the illumination source, which is an indicator of whether the object is within the scanning volume. Accordingly, at 612, the intensity of the pixels of the foreground mask immediately after the illumination is turned on is compared against the intensity of the same pixels of the foreground mask taken immediately after the illumination is turned on, and the difference in intensity is compared against a threshold at 814. If the threshold is exceeded, the object is determined to be within the scanning volume, and the process advances to initiate the tracking decision logic at 816. The S-transform channels for the X and Y directions, S_{X} 805C and S_{Y} 805D, are passed to the tracking decision logic for processing.

FIG. 9 is a flow diagram illustrating process 900, which is a particular implementation of certain operations 808-816 according to a specific embodiment. At 902, the illumination-off background-reduction model is applied as part of background-reduction operation 806. At 904, object detection engine 402 computes foreground mask 807 using the applied background-reduction model. At decision 906, the size of the foreground mask is compared against a first threshold, TH1_ON, which is an initial threshold to detect the possible presence of an object so as to turn on the illumination system 112.

To avoid false detections that may lead to rapid flashing of illumination system 112, a temporal condition is also applied. In particular, the TH1_ON threshold should be exceeded for H1 frames. To determine if the temporal condition is met, the size of the foreground mask 807 from H1 prior frames is stored and checked as part of decision 906.

Decision 908 provides an alternative initial-detection criteria, namely, whether the foreground mask size is so large that an object is deemed to be likely present without regard to prior frames. In one such embodiment, decision 908 checks if the foreground mask size exceeds a size threshold, of TH1_ON*10. If no object is detected in the foreground, process 900 branches to 910 to train the illumination-off background-reduction model, and then to decision 926 to check if the foreground mask size is below a threshold for returning the system to an idle state, TH1_OFF. If such is the case, the illumination is switched off at 928 (if it was on from a prior frame), and processing for the current frame is concluded at 930.

If either criteria for the initial object detection of decisions 906-908 is met, process 900 switches on the illumination at 912. Illumination may be effected via illumination control engine 408 in some embodiments. At 914, object detection engine 402 applies the illumination-on background reduction model. At 916, foreground mask 915 is computed using the S-transform outputs and the illumination-on background-reduction model.

Decision 918 applies criteria for determining if motion tracking should be initiated. Accordingly, the size of the foreground mask is compared against a second threshold, TH2_ON. If the size exceeds threshold TH2_ON, motion tracking is started at 920. If the foreground mask size is not greater than threshold TH2_ON, decision 922 checks whether the size of the foreground mask is less than threshold TH2_OFF for ending the scan sequence and tracking operations. If such is the case, these operations are concluded at 924. Otherwise, the tracking and scan sequence state is maintained and processing advances to the next captured image frame at 930. At the conclusion of the scan sequence and object tracking, following 924, decision 926 determines whether the possible-object state with illumination active should be ended, as discussed above.

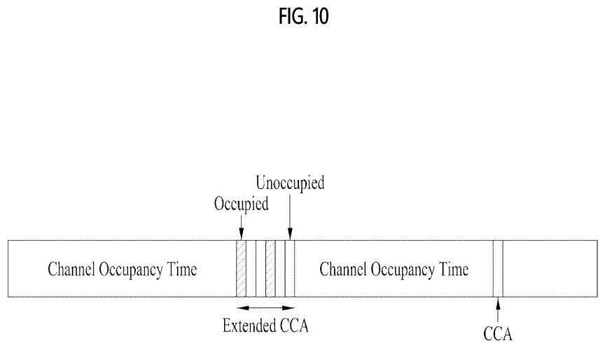

FIG. 10 is a flow diagram illustrating motion-tracking process 1000 which may be carried out by motion tracking engine according to an example. Motion-tracking process 1000 is an example of operations 712-732 (FIG. 4) with certain computations and decision criteria shown in greater detail. Process 1000 may be called by operation 920 of process 900 (FIG. 9) when the criteria of object size and/or duration are met as described above. At 1002, phase correlation is computed to determine a translation vector of the object. Input 1001 to the phase correlation operation includes a set of the S_{X}, S_{Y}, and MIN outputs of S-transform operation 804, indicated respectively at 805B, 805C, and 805D.

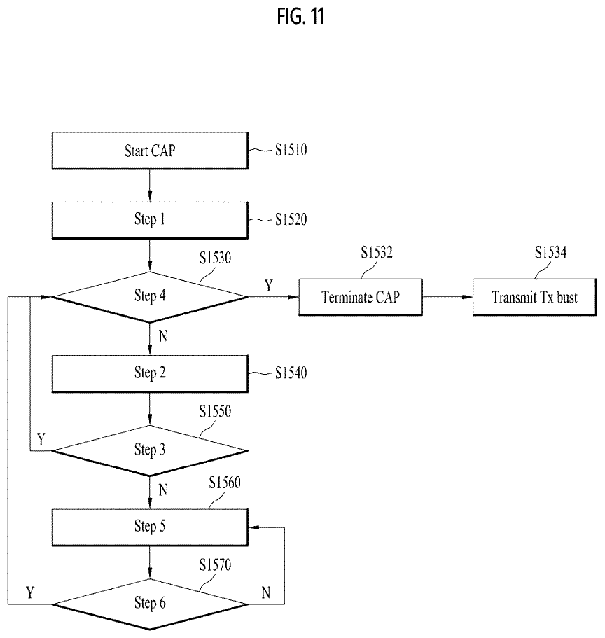

FIG. 11 is a flow diagram illustrating an example set of operations of phase correlation 1002. At 1102, input 1001 is accessed for the current frame. In one type of embodiment, the block size for the Stransform is 16×16 pixels, although other block sizes are also contemplated for other embodiments. At 1104, each channel of input 1001 is multiplied by the previously-computed binary foreground mask. At 1106, each channel is multiplied with a precomputed Hamming window. At 1108, the Fourier transform of the 3 channels is computed. at 1110, the cross-power spectrum of the FFT of each channel is computed with the complex conjugate of the FFT of the correspondent S-transorm channel of the previous frame. This prior FFT is available from the prior iteration when the previous frame was processed; hence, it can be retrieved from data store 418 instead of having to be repeated in the present iteration.

At 1112, the inverse FFT of the results is computed to obtain the cross-correlation heat map for each channel. At 1114, for each channel the position of the strong local peaks by is calculated applying a NonMaximaSuppression algorithm. At 1116, for each channel the coordinate of the strongest peak is determined as the estimated values of the translation vector Δx and Δy (in the S-tranform coordinate system). At 1118, a confidence measure is computed for each channel as the ratio between the value of the strongest peak and the value the second-strongest peak. At 1120, the estimated translation vector is identified as the vector corresponding to the peak with the highest confidence among all three channels. At 1122, the translation vector and the corresponding confidence score are returned as the output of the phase correlation operation 1002.

Referring again to FIG. 10, at 1004 the magnitude of the translation vector at the output of phase correlation operation 1002 is compared to threshold TH3_ON to determine whether criteria is met to recognize a scanning sequence. In the affirmative case, at 1006, process 1000 advances to processing the next iteration at 1010, and records the motion vector data as part of the scan sequence in data store 418. Also, because the amount of motion of the object is considered high enough to avoid being deemed part of the background, training of the background for the motion-tracking background model may be performed at 1022.

If threshold TH3_ON is not met, training of the motion-tracking background model is turned off at 1024. In addition, decision 1012 determines whether the sub-TH3_ON condition has been the case for longer than H2 frames. In the affirmative case, motion tracking is ended at 1014, and the process advances to the next iteration at 1010. In addition, if the motion vector's magnitude has remained below threshold TH3_ON for longer than H3 frames (where H3>H2), as determined at decision 1018, then the scan sequence is ended at 1020.

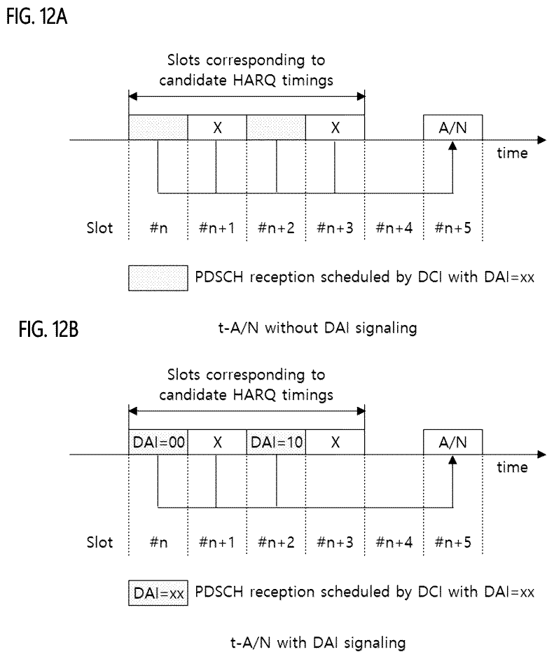

FIG. 12 is a state-machine diagram of various states and conditions for changing states according to an embodiment of scanning system 100 which implements additional thresholds. For each image frame, the states are ILLUMINATION OFF, ILLUMINATION ON, MOTION TRACKING, and SCANNING SEQUENCE. In each state, various criteria are monitored. In the ILLUMINATION OFF state, the possible presence of an object in the scanning volume is monitored. In the ILLUMINATION ON state, possible motion of a detected object is monitored. In the MOTION TRACKING and SCANNING SEQUENCE states, the extent of motion is monitored. As discussed above, the monitored conditions of the various states include size of the foreground mask, denoted FG MASK; duration measured as a count of image frames, denoted F; and magnitude of the motion vector, denoted MV.

The size of the foreground mask, FG MASK, is compared against size thresholds including (in order of increasing value) TH1_OFF, TH1_ON, TH2_OFF, and TH2_ON. The durations of various conditions are compared against temporal thresholds (as measured in frame quantity) denoted H1, H2, and H3. The motion vector magnitude MV is compared against magnitude thresholds TH3_OFF and TH3_ON. In this embodiment, the pairings of thresholds with _OFF and _ON suffixes are utilized to provide hysteresis and thus improve state stability. Likewise, the temporal thresholds H1, H2, and H3 are used to ensure that a given condition is reliably present, creating immunity to potentially noisy values of monitored conditions, and further improving state stability. The operations denoted FRAME COUNT++ indicates that the process advances to the next iteration.

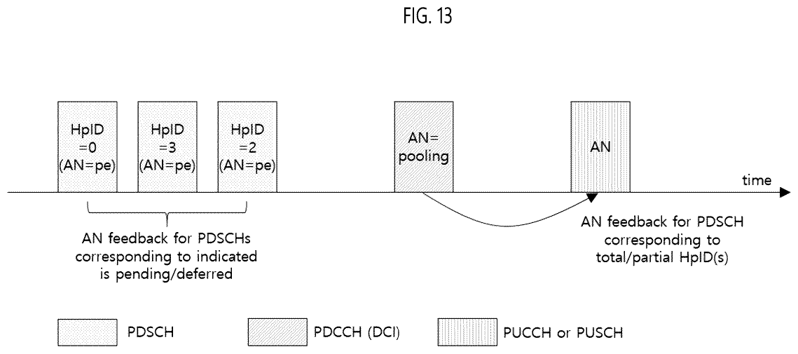

FIG. 13 is a timing diagram illustrating a basic example of operational iterations through the state machine of FIG. 12 that results in a starting and stopping of a scan sequence. Time advances discretely along the horizontal axis, with image frames occurring at each successive time step. Various quantities are represented along the vertical axis.

According to the initial conditions, the foreground mask FG MASK size is zero; phase correlation is not active; no motion vector has been measured; the ILLUMINATION state is OFF; and no scan sequence is being recorded. At time T, the FG MASK size exceeds threshold TH1_ON, and this state remains for a duration that exceeds temporal threshold H1 at T2. This combination of conditions having been met causes the ILLUMINATION to be turned ON. At T3, FG MASK size exceeds threshold TH2_ON, which causes the phase correlation to start tracking movement of the foreground mask. At time T4, the motion vector magnitude exceeds threshold TH3_ON, which causes the scan sequence to start. At time T5the motion vector magnitude drops below threshold TH3_ON but not below TH3_OFF, which has no effect on the states.

At time T6, the FG MASK size falls below TH2_OFF, which causes the phase correlation to stop tracking. Likewise, the scan sequence is ended due to the motion vector falling below threshold TH3_OFF. At T7, the FG MASK size drops below threshold TH1_OFF, which causes the ILLUMINATION state to change to OFF.

Notably, two conditions need to be satisfied for a scanning sequence to start: first, the motion tracking state needs to be active; and second, the motion vector magnitude must be higher than threshold TH3_ON. These conditions represent the case when the object appears in the scanning volume and moves within it. If a scanning sequence is initiated, it can only end if either of two conditions is met: the foreground mask size is lower than threshold TH2_OFF, or the motion vector magnitude is lower than threshold TH3_OFF and remains lower than threshold TH3_ON for at least H3frames. This latter condition protects against the possibility of leaving the scanning sequence active indefinitely where, for example, a miscalculated foreground mask may be generated from a sudden change in the background, such as a sudden change in the ambient lighting.

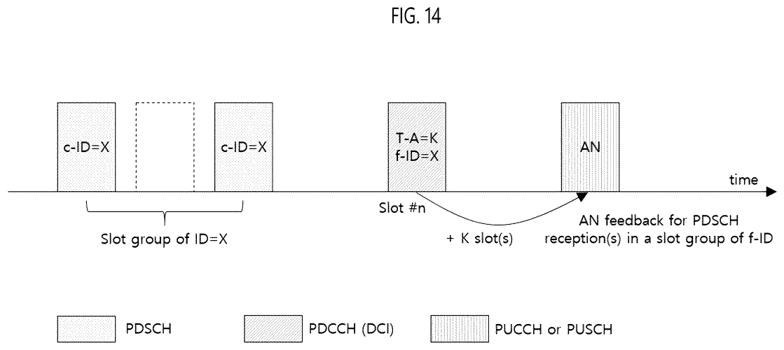

FIG. 14 is a timing diagram illustrating usage of the background-reduction models for computation of the foreground masks in the object detection, as well as training operations of those models. As depicted, initially, the ILLUMINATION-OFF background reduction model is used. While the ILLUMINATION-OFF background reduction model is in use, training is performed since no object is detected within the scanning volume.

At time T1, the ILLUMINATION state is turned to ON in response to the foreground mask FG MASK size exceeding the first threshold, TH1_ON, as described above. In response, the ILLUMINATION-OFF background reduction model is no longer used, and instead the ILLUMINATION-ON background reduction model is used. At this point, since an object is believed to be in the scanning volume, no training is performed of the ILLUMINATION-ON background reduction model. At time T2, the motion vector exceeds threshold TH3_ON, indicating that the object is confirmed to be in motion. Hence, training of the ILLUMINATION-ON background reduction model is performed since the moving object will not be considered as part of the background.

At time T3, the motion vector magnitude drops below threshold TH3_OFF. Accordingly, training of the ILLUMINATION-ON background reduction model is halted since the motion of the object may not be sufficient to discriminate the object from the background. At time T4 the motion vector magnitude returns to a level that exceeds threshold TH3_ON, and training is resumed until time T5, when the ILLUMINATION state is turned to OFF. At this point, the ILLUMINATION-ON background reduction model is no longer used, and instead the ILLUMINATION-OFF background reduction model is used, and trained.

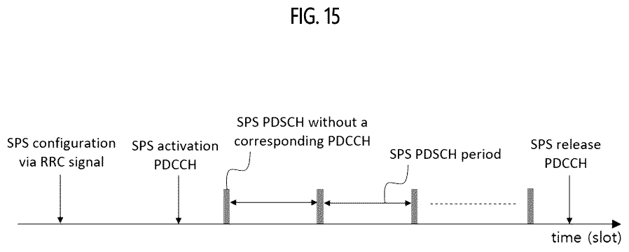

FIG. 15 is a timing diagram illustrating an example use case where a scan sequence is started normally, but is terminated when the object becomes still for some period of time. As shown, when the foreground mask, FG MASK size exceeds first threshold TH1_ON at time T1 and remains so for a duration of H1 frames, the ILLUMINATION state is turned ON at time T2. At time T3, second threshold TH2_ON is exceeded by the FG MASK size and, in response, the motion tracking is started by operation of the phase correlation. At T4 the motion vector exceeds threshold TH3_ON, and as a result, the scan sequence is started.

At time T5, the motion vector magnitude falls below threshold TH3_OFF, and remains below TH3_ON for at least duration H3. At the expiration of duration H3, at time T6, the scan sequence and motion tracking are both ended.

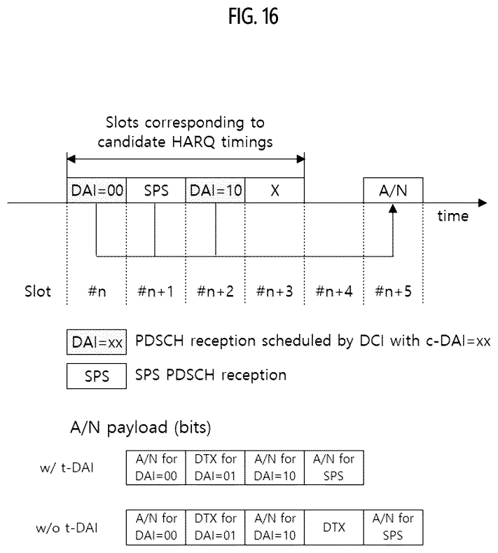

FIG. 16 is a timing diagram illustrating an example use case where a scanning sequence is not started for lack of movement in the scanning volume. As in the prior examples of FIGS. 13 and 15, when the foreground mask, FG MASK size exceeds first threshold TH1_ON at time T1 and remains so for a duration of H1 frames, the ILLUMINATION state is turned ON at time T2. At time T3, second threshold TH2_ON is exceeded by the FG MASK size and, in response, the motion tracking is started by operation of the phase correlation.

However, the motion vector magnitude in this example does not exceed threshold TH3_ON. Accordingly, the scan sequence is not started. After the passage of duration H2, ending at time T4, the motion tracking is turned off. The ILLUMINATION state is turned off at time T5 in response to the FG MASK size falling below threshold TH1_OFF.

### Image Stitching

In image stitching, as performed by image stitching engine 414 (FIG. 4), the dimensionality reduction provided by the S-transform is used since it operates in the S-transform feature domain and the foreground detection and image correlation to determine the linear displacement of an object in two subsequent frames of a sequence.

The foreground detection is used to limit the alignment task on the portion of the image that contains the item. Whereas in general image stitching scenarios a common assumption is that the whole image is moving, embodiments of image stitching engine 414 take advantage of the fact that the captured images each have a portion that is still or mostly unchanged in a sequence. For example, image frames each have a non-moving background, and a foreground portion that is moving across the scene. Linear motion detection is used with the premise that the movement in between two subsequent frames can be approximated as a two-dimensional translation of the object.

Use cases for image stitching include fixed retail scanners, and fixed parcel detection scanners.

The fixed retail scanner scenario involves the presentation of the composited or stitched image to the operator so that an item from a scanning sequence can be easily and quickly identified from another scanning sequence in the bagging area. Thus, the stitched image may be provided to and displayed by an electronic display, such as the customer checkout screen of a self-checkout station, a checker display screen of an assisted checkout lane, and/or other connected device, such a mobile device of an employee monitoring a self-checkout area, a mobile device belonging to the customer, etc. There are a number of reasons for which a scanning system can advantageously point the operator's attention to a particular object from a scanning sequence, especially for a self-checkout system. For instance, the object passed across the scanner may not have been read properly (e.g., no symbol found). In this case, the operator needs to find the item in the bagging area and rescan it. Further, the item detected may not match some of the characteristics of the item described by the symbol's code (such as weight or image features possibly used to validate a symbol reading). In this case, the operator can compare the composite image with the UPC description to validate the expectation. Moreover, certain objects may have a restriction associated with them that require the attention of an operator such as a retail-checkout cashier. Examples of such objects include age-restricted items such as alcohol, lottery tickets, cigarettes, certain medications, or the like. In this case, having an image of the object in question allows the cashier to indicate to the customer, right away, the object which generated an exception or flag.

In each of these scenarios, the operator (e.g., a cashier, a customer, or other person involved in a transaction) may be alerted that a particular object which was passed across the scanner represents an exception or flag. To identify the product in question it is beneficial to present to the operator a single image that can visually help the operator quickly single out the product at issue from among a large pile of objects in the bagging area or other location in the checkout area. This can be done much effectively than using a simple video clip of the scan. A single image identifier also eliminates the need of having to rely solely on the UPC description to identify a product among many others.

In fixed parcel detection scanner applications, one single image is generated from multiple images captured of a parcel passing underneath a fixed 2d scanner over a conveyor. In this particular scenario, it may be needed for the system to transfer the images of a sequence from the scanner to a separate computation engine for the purpose of image analysis (such as a “no read engine” application or for package classification) or for image storage since in some application it may be desired to store the images of a particular parcel at a certain stage of the parcel's transportation (for example, to determine whether a package has been damaged and where, or whether to perform package re-identification). In any of these scenarios, multiple images are generally stored since the package may be only partially visible in any given image of a sequence, and this entails a substantial data bandwidth that needs to be guaranteed to allow the transfer of each sequence.

Using solutions of the embodiments discussed herein, it is possible to condense all the images of a sequence of a passing item into one single image that shows the whole parcel at once. Also, by using the knowledge of the foreground, image stitching engine 414 may crop the image only around the portion that contains the parcel.

Therefore, by sending only one composite image, it is possible to diminish the bandwidth necessary for image transfer and also the storage space per parcel.

The solution according to some embodiments presumes uniform velocity and direction of an item in a single sequence, as is often the case for conveyor-based object movers. Different packages may move at different velocities in relation to the image-capture device, based on the height of the package and on variations of the speed of the conveyor but it is safe to assume that across a single sequence (for a single parcel) the velocity is uniform. It also provides the advantage that the system does not need to be configured or connected to the conveyor controller since it automatically determines the motion vector of an object in a sequence for every sequence.

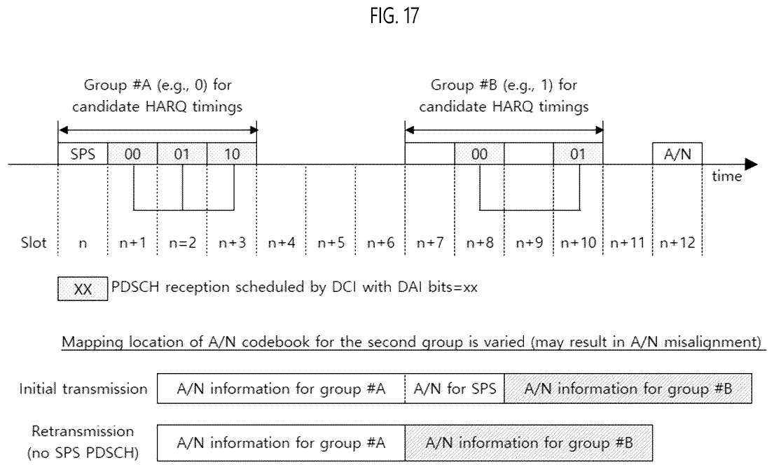

FIG. 17 is a structural diagram illustrating image stitching engine 414 according to an example embodiment. As depicted, image stitching engine 414 includes processing hardware 200, and instructions 1702 stored on one or more non-transitory storage media and executable by computing hardware 200 to implement image stitching engine 414 according to this example. Instructions 602, when executed, cause the computing hardware 200 to implement the following process, which may be performed with different orderings of operations unless certain operations are specifically called out as being performed in sequence. In some variations, certain operations may be modified or omitted.

At 1712, input is received, which includes image frames belonging to a sequence of images. At 1714, image stitching engine 414 computes a transform operation on each image frame to produce a frequency-spatial representation. In some embodiments, operation 1714 is the same operation as operation 614 described above with reference to object detection engine 402 (FIG. 6). In some implementations, a S-transform is computed as in operation 804 (FIG. 8). The same downsampling may also be performed as part of the transform operation as discussed above in operation 616 (FIG. 6). At 1716, a background-subtraction operation is performed. This computation may be the same as operation 618 (FIG. 6). Likewise, the training of the background reduction statistical models may be utilized.

At 1718, image stitching engine 414 computes a phase correlation process, such as process 1102 (FIG. 11). As a result, the motion vectors and confidence values for each image frame are obtained.

In some embodiments, the results of operations 1712-1718 are obtained from prior processing during the object-detection and scanning-sequence processing as described above, such that the computations to obtain the results are not repeated by image stitching engine 414. In other embodiments, where the pre-computed results are not available, image stitching engine 414 completes the necessary computations.

At 1720, additional inputs are received. These may include an index for the frame that will be composited in the output image so that it will prevent the least amount of seam artifacts. Also, the additional inputs may include a binary setting that, when true, causes image stitching engine 414 to use the assumption of a constant speed and direction of the object's movement in the scanning volume, to refine the values of the motion vector list. The additional inputs may also include an image crop parameter setting, which may be a binary value that indicates whether the output image should be cropped around the object in the foreground.

At 1722, input preprocessing may be performed. This operation includes convolving the list of motion vectors with a 3×1 median filter along each of the X and Y axes to remove outlying values.

At 1724, a default motion vector is computed. When process 1702 is set to assume a constant speed and direction for a scanning sequence, the default motion vector is computed as the average of the motion vectors associated with a confidence higher than 0.8. If no item with a confidence higher than 0.8 is found the translation vector associated with the highest confidence may be used. The default translation vector value is then assigned to all the elements in the translation vector list for which the corresponding confidence value is lower than 0.6.

At 1726 a distance-vector list is computed from the motion vector list, which contains the estimated motion vector of a frame from the previous iteration in the sequence list. The distance-vector list contains the 2D distance vector for each frame, as measured from the first frame of the sequence. The distance-vector list is used to compute the minimum value and the maximum value along the X axis and the Y axis. The min vector (min_{X}, min_{Y}) is then subtracted from the distance vector list so that each element from the distance vector list represents the position of the related frame in relation to the top left corner of the composite image. The min vector and max vector are also used to determine the size of the final composite image (width=max_{X}−min_{X} and height=max_{Y}−min_{Y}).

At 1728, the frame order overlay is computed. The frame overlay operation determines which portion of the frame will present the largest amount of area free of seams artifacts. If the main frame index is specified as part of the input at 1720, the frame associated with that position in the list is selected, otherwise, the frame overlay algorithm attempts to estimate the best frame based on the size of the foreground mask and how centered the frame is in relation to the sequence.

In some embodiments, in which preserving the integrity of the readable symbol against seams artifacts is prioritized, the system may specify the frame to preserve the greatest portion of the readable symbol according to different various approaches. For instance, if a symbol is detected in one or multiple frames, the frame index corresponding to the position of the detected symbol is the most centered in relation to the frame boundaries. In another example, if a partial symbol is detected, its position may be used in the frame and the frame index to determine the frame index indicator.

In a related embodiment, an external label detector system may be used to determine the position of the label on the object and, subsequently, determine the main frame index, with the advantage that with a label detector the position of the label is determinable even when it is not possible to detect a partial symbol.

In other embodiments, it may be preferable to identify the main frame index to determine a heuristic to find the largest and center-most image of the sequence, to obtain the best results when it comes to stitching the images together. To this end, the frame list may be ordered in ascending order according to a score computed as a weighted sum of foreground mask coverage (mask_size/image_size) and distance to the centermost index of the sequence (abs((sequence_lenght)/2-index)).

After identifying the main frame index, the frame overlay operation 1728 determines the best order in which to overlay the images on the final composite image in order to maintain that adjacent images in the composite are also adjacent in the sequence and that the main frame is placed as the last image on top of the other frames so as to maximize the area of the image without seams. For instance, in one example, ordering={0, 1, . . . , main_frame_indx−1, last_index, last_index−1, . . . , main_frame_index+1, main_frame_index}

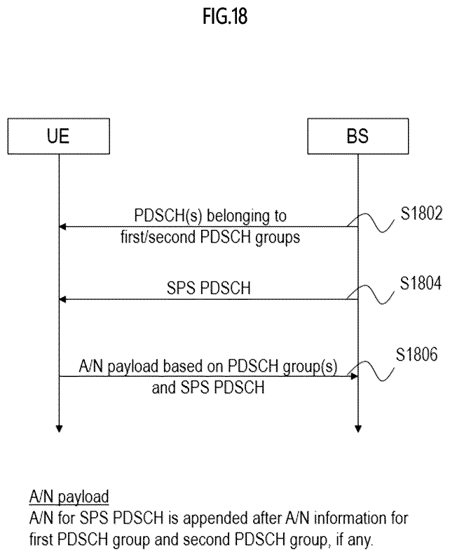

FIG. 18 is a diagram illustrating an example ordering in which the images are composed in the final composite image in relation to the original ordering of the sequence, with the frame on top representing the one selected as the main frame.

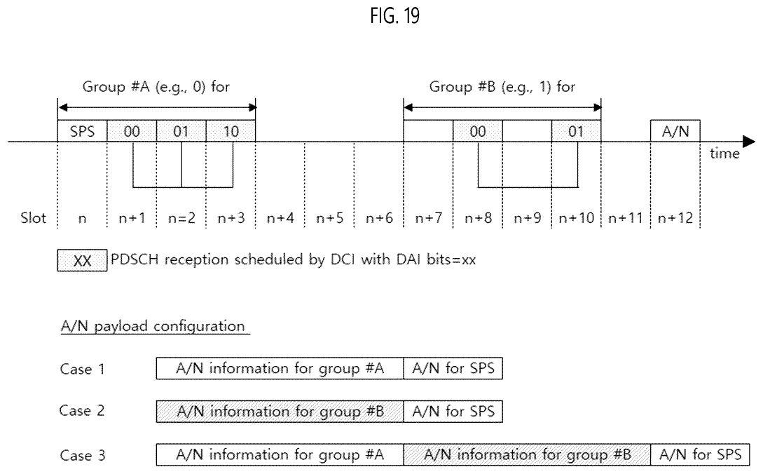

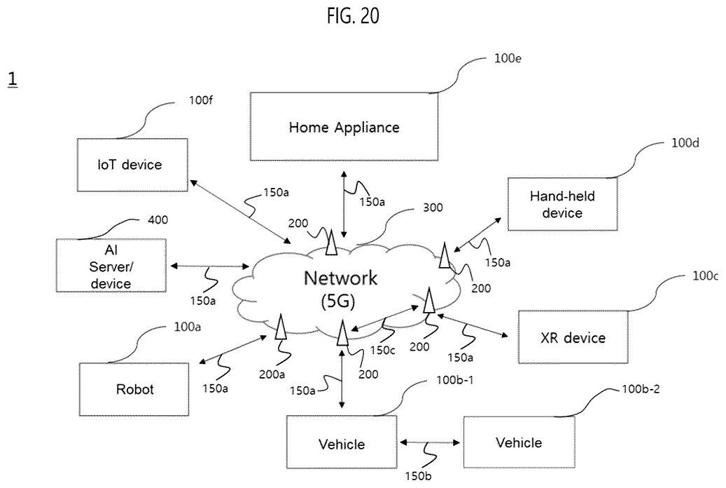

Referring again to FIG. 17, at 1730, the partial images are blended into a composite image based on the established ordering. An initial blank image is first created, and then filled in with each image of the sequence as images are overlaid according to the positions defined in the distance vector list and according to the determined order. In a related example, in order to blend the image with the previous one so as to minimize the seam effect, a 2D Tukey window function with α=0.3 may be used. A 1D Tukey function is defined as shown in FIG. 19, where the operator ⊗ indicates the outer product of a and b. FIG. 20 is a visual example of a 2d Tukey window with α=0.3. FIG. 20 is a graphical illustration of a Tukey window with α=0.3.

Blending the frame F of size w,h in the composite image A at an offset x,y using the Tukey blending window function t can be described by the equation below:

$${A}_{i + x}^{j + y} = {A}_{i + x}^{j + y} * ( 1 - t ) + {F}_{i}^{j} * t$$

$$i = 0 , 1 , … w and y = 0 , 1 , … h$$

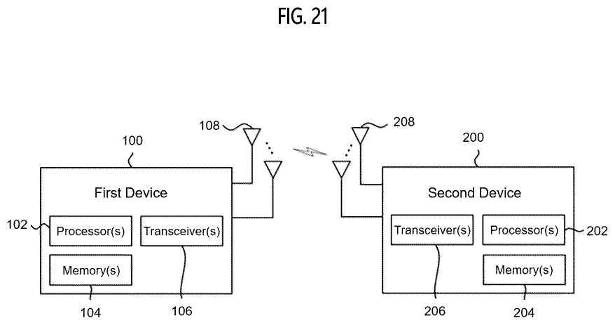

FIGS. 21A and 21B illustrate an example of a composite image, before and after Tukey blending, respectively.

Returning to FIG. 17, operation 1730 optionally may be used to crop the resulting composite image around the object, readable symbol, or other feature of interest. To this end, the foreground masks of the frames of the sequence may be composited to generate a complete foreground mask from which a bounding box may be determined. In a related example, an extra safety margin may be specified for cropping the composite image as a percentage of the width and height of the bounding box of the region of interest.

For improved computational efficiency, it is possible to pass the mask list in a downsampled format to speed up the process of creation of the composite foreground item mask and defining the bounding box.

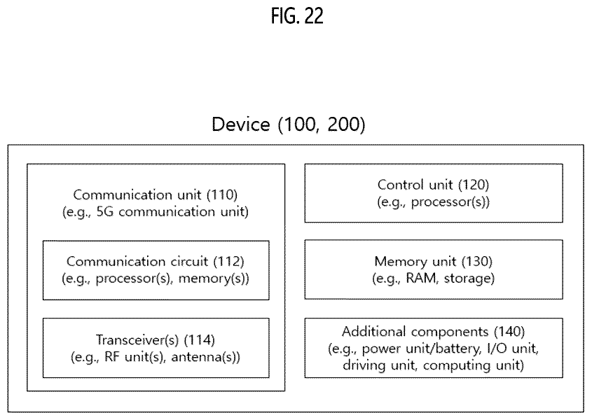

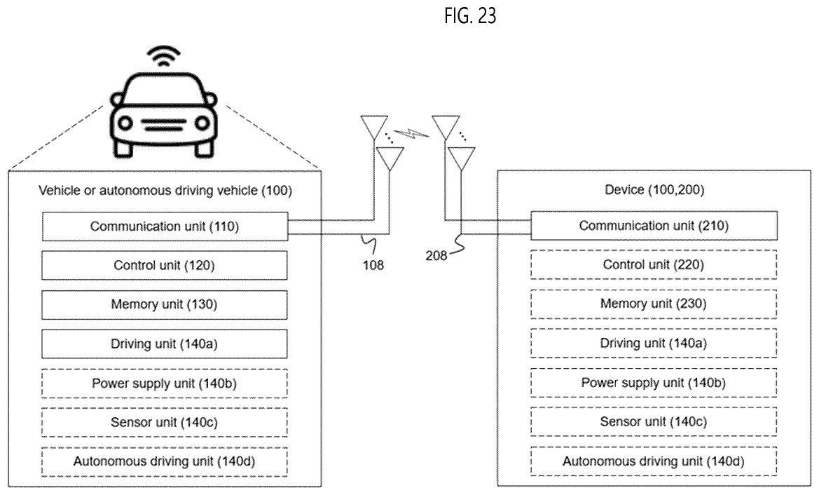

To illustrate the input and output images of process 1702, FIG. 22 shows a series of images 2202 as inputs to the process, each of which contains only a portion of an object. The composite image 2204 as the output of the image stitching operations.

### Additional Notes and Examples

Example 1 is a motion tracking system for processing a series of captured image frames to assess movement of an object in a scanning volume and provide an output to a symbol-reading system, the motion tracking system comprising: an input to receive the series of captured image frames of the scanning volume; an object detection engine operatively coupled to the input to perform first autonomous processing of the captured image frames, wherein the first autonomous processing includes: for each image frame, computation of a transform to a frequency-spatial representation of that image frame; and computation of a background reduction of the frequency-spatial representation based on a trained statistical model of a background of the scanning volume to produce a foreground mask representing the object; a motion tracking engine operatively coupled to the object detection engine to perform second autonomous processing of the foreground mask, wherein the second autonomous processing includes: computation of a motion vector representing motion of the object from the at least one prior image frame to the current image frame; application of object tracking criteria to the motion vector to assess an extent of motion of the object in the scanning volume; in response to the extent of motion in the scanning volume, performance of the sequence scanning, including storage of the motion vector corresponding to the current image frame as part of a sequence that includes, a plurality of motion vectors corresponding to a plurality of image frames, wherein the sequence collectively characterizes motion of the object in the scanning volume over the plurality of image frames; and an output operatively coupled to the motion tracking engine and to a symbol-reading system, the output to indicate characteristics of movement of the object in the scanning volume, wherein the output, in combination with a symbol reading result, is indicative of a failed symbol-reading attempt.

In Example 2, the subject matter of Example 1 includes, wherein each captured image frame is of a first resolution, and wherein the transform to the frequency-spatial representation includes a reduction of resolution to a second resolution that is less than the first resolution.

In Example 3, the subject matter of Examples 1-2 includes, wherein the frequency-spatial representation includes a plurality of channels, and wherein computation of the phase correlation includes processing of the plurality of channels.

In Example 4, the subject matter of Examples 1-3 includes, wherein the transform is an S-transform.

In Example 5, the subject matter of Examples 1-4 includes, wherein the frequency-spatial representation includes frequency information along x and y axes, and neighborhood maxima and minima values.

In Example 6, the subject matter of Examples 1-5 includes, wherein the trained statistical model is trained to account for an illumination state of the scanning volume.

In Example 7, the subject matter of Examples 1-6 includes, wherein the first autonomous processing includes application of object detection criteria to the foreground mask to assess a presence of the object in the scanning volume as a prerequisite to performance of the second autonomous processing.

In Example 8, the subject matter of Examples 1-7 includes, wherein the second autonomous processing includes application of sequence-scanning-initiation criteria to the assessment of extent of motion to authorize sequence scanning.

In Example 9, the subject matter of Examples 1-8 includes, wherein computation of the motion vector includes performance of a phase correlation between the foreground mask of a current image frame and at least one prior image frame.

In Example 10, the subject matter of Examples 1-9 includes, a training engine operatively coupled to the object detection engine, the training engine operative to perform training of the statistical model in response to either a non-detection of any object in the scanning volume, or the extent of motion of the object being indicative of the object moving in the scanning volume.

In Example 11, the subject matter of Examples 1-10 includes, an illumination system operatively coupled to the object detection engine to illuminate the scanning volume in response to initial detection of a possible presence of the object in the scanning volume based on a size of the foreground mask.

In Example 12, the subject matter of Examples 1-11 includes, an image stitching engine operatively coupled to the motion tracking engine to produce a composite image from a series of captured image frames by stitching together portions of the captured image frames based on the characteristics of movement of the object in the scanning volume.

In Example 13, the subject matter of Example 12 includes, wherein the stitching engine is operative to select an image frame containing a centrally-located region of interest as a main image frame to reduce image distortion due to seams resulting from stitching in the region of interest.

In Example 14, the subject matter of Examples 12-13 includes, an operator interface operatively coupled to the image stitching engine to display the composite image.

In Example 15, the subject matter of Examples 1-14 includes, the symbol-reading system.

Example 16 is an automated method for assessing movement of an object in a scanning volume and providing an output to a symbol-reading system to assess success of a symbol-reading attempt, the method comprising: receiving a series of captured image frames of the scanning volume; for each image frame, computing a transform to a frequency-spatial representation of that image frame; and computing a background reduction of the frequency-spatial representation based on a trained statistical model of a background of the scanning volume to produce a foreground mask representing the object; computing a motion vector representing motion of the object from the at least one prior image frame to the current image frame; applying object tracking criteria to the motion vector to assess an extent of motion of the object in the scanning volume; in response to the extent of motion in the scanning volume, performing sequence scanning, including storing the motion vector corresponding to the current image frame as part of a sequence that includes, a plurality of motion vectors corresponding to a plurality of image frames, wherein the sequence collectively characterizes motion of the object in the scanning volume over the plurality of image frames; and providing an output to a symbol-reading system to indicate characteristics of movement of the object in the scanning volume, wherein the output, in combination with a symbol reading result, is indicative of a failed symbol-reading attempt.

In Example 17, the subject matter of Example 16 includes, wherein each captured image frame is of a first resolution, and wherein computing the transform to the frequency-spatial representation includes reducing a resolution to a second resolution that is less than the first resolution.

In Example 18, the subject matter of Examples 16-17 includes, wherein the frequency-spatial representation includes a plurality of channels, and wherein computing the phase correlation includes processing of the plurality of channels.

In Example 19, the subject matter of Examples 16-18 includes, wherein computing the transform includes computing an S-transform.

In Example 20, the subject matter of Examples 16-19 includes, wherein in computing the transform, the frequency-spatial representation includes frequency information along x and y axes, and neighborhood maxima and minima values.

In Example 21, the subject matter of Examples 16-20 includes, wherein computing the motion vector includes performing a phase correlation between the foreground mask of a current image frame and at least one prior image frame.

In Example 22, the subject matter of Examples 16-21 includes, performing training of the statistical model in response to either a non-detection of any object in the scanning volume, or the extent of motion of the object being indicative of the object moving in the scanning volume.

In Example 23, the subject matter of Examples 16-22 includes, Illuminating the scanning volume in response to initial detection of a possible presence of the object in the scanning volume based on a size of the foreground mask.

In Example 24, the subject matter of Examples 16-23 includes, producing a composite image from a series of captured image frames by stitching together portions of the captured image frames based on the characteristics of movement of the object in the scanning volume.

In Example 25, the subject matter of Example 24 includes, selecting an image frame containing a centrally-located region of interest as a main image frame to reduce image distortion due to seams resulting from stitching in the region of interest.

Example 26 is at least one machine-readable medium including instructions that, when executed by processing circuitry, cause the processing circuitry to perform operations to implement of any of Examples 16-25.

Example 27 is an apparatus comprising means to implement of any of Examples 16-25.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalents.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as will be understood by persons of ordinary skill in the art.

Any incorporation by reference of documents above is limited such that no subject matter is incorporated that is contrary to the explicit disclosure herein. Any incorporation by reference of documents above is further limited such that no claims that are included in the documents are incorporated by reference into the claims of the present Application. The claims of any of the documents are, however, incorporated as part of the disclosure herein, unless specifically excluded. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A motion tracking system for processing a series of captured image frames to assess movement of an object in a scanning volume and provide an output to a symbol-reading system, the motion tracking system comprising:
an input to receive the series of captured image frames of the scanning volume;
an object detection engine operatively coupled to the input to perform first autonomous processing of the captured image frames, wherein the first autonomous processing includes:
for each image frame, computation of a transform to a frequency-spatial representation of that image frame; and
computation of a background reduction of the frequency-spatial representation based on a trained statistical model of a background of the scanning volume to produce a foreground mask representing the object;
a motion tracking engine operatively coupled to the object detection engine to perform second autonomous processing of the foreground mask, wherein the second autonomous processing includes:
computation of a motion vector representing motion of the object from the at least one prior image frame to the current image frame;
application of object tracking criteria to the motion vector to assess an extent of motion of the object in the scanning volume;
in response to the extent of motion in the scanning volume, performance of the sequence scanning, including storage of the motion vector corresponding to the current image frame as part of a sequence that includes a plurality of motion vectors corresponding to a plurality of image frames, wherein the sequence collectively characterizes motion of the object in the scanning volume over the plurality of image frames; and
an output operatively coupled to the motion tracking engine and to a symbol-reading system, the output to indicate characteristics of movement of the object in the scanning volume, wherein the output, in combination with a symbol reading result, is indicative of a failed symbol-reading attempt.

2. The motion tracking system of claim 1, wherein each captured image frame is of a first resolution, and wherein the transform to the frequency-spatial representation includes a reduction of resolution to a second resolution that is less than the first resolution.

3. The motion tracking system of claim 1, wherein the frequency-spatial representation includes a plurality of channels, and wherein computation of the phase correlation includes processing of the plurality of channels.

4. The motion tracking system of claim 1, wherein the transform is an S-transform.

5. The motion tracking system of claim 1, wherein the frequency-spatial representation includes frequency information along x and y axes, and neighborhood maxima and minima values.

6. The motion tracking system of claim 1, wherein the trained statistical model is trained to account for an illumination state of the scanning volume.

7. The motion tracking system of claim 1, wherein the first autonomous processing includes application of object detection criteria to the foreground mask to assess a presence of the object in the scanning volume as a prerequisite to performance of the second autonomous processing.

8. The motion tracking system of claim 1, wherein the second autonomous processing includes application of sequence-scanning-initiation criteria to the assessment of extent of motion to authorize sequence scanning.

9. The motion tracking system of claim 1, wherein computation of the motion vector includes performance of a phase correlation between the foreground mask of a current image frame and at least one prior image frame.

10. The motion tracking system of claim 1, further comprising:
a training engine operatively coupled to the object detection engine, the training engine operative to perform training of the statistical model in response to either a non-detection of any object in the scanning volume, or the extent of motion of the object being indicative of the object moving in the scanning volume.

11. The motion tracking system of claim 1, further comprising:
an illumination system operatively coupled to the object detection engine to illuminate the scanning volume in response to initial detection of a possible presence of the object in the scanning volume based on a size of the foreground mask.

12. The motion tracking system of claim 1, further comprising:
an image stitching engine operatively coupled to the motion tracking engine to produce a composite image from a series of captured image frames by stitching together portions of the captured image frames based on the characteristics of movement of the object in the scanning volume.

13. The motion tracking system of claim 12, wherein the stitching engine is operative to select an image frame containing a centrally-located region of interest as a main image frame to reduce image distortion due to seams resulting from stitching in the region of interest.

14. The motion tracking system of claim 12, further comprising:
an operator interface operatively coupled to the image stitching engine to display the composite image.

15. The motion tracking system of claim 1, further comprising the symbol-reading system.

16. An automated method for assessing movement of an object in a scanning volume and providing an output to a symbol-reading system to assess success of a symbol-reading attempt, the method comprising:
receiving a series of captured image frames of the scanning volume;
for each image frame, computing a transform to a frequency-spatial representation of that image frame; and
computing a background reduction of the frequency-spatial representation based on a trained statistical model of a background of the scanning volume to produce a foreground mask representing the object;
computing a motion vector representing motion of the object from the at least one prior image frame to the current image frame;
applying object tracking criteria to the motion vector to assess an extent of motion of the object in the scanning volume;
in response to the extent of motion in the scanning volume, performing sequence scanning, including storing the motion vector corresponding to the current image frame as part of a sequence that includes a plurality of motion vectors corresponding to a plurality of image frames, wherein the sequence collectively characterizes motion of the object in the scanning volume over the plurality of image frames; and
providing an output to a symbol-reading system to indicate characteristics of movement of the object in the scanning volume, wherein the output, in combination with a symbol reading result, is indicative of a failed symbol-reading attempt.

17. The method of claim 16, wherein each captured image frame is of a first resolution, and wherein computing the transform to the frequency-spatial representation includes reducing a resolution to a second resolution that is less than the first resolution;
wherein the frequency-spatial representation includes a plurality of channels, and wherein computing the phase correlation includes processing of the plurality of channels; and
wherein in computing the transform, the frequency-spatial representation includes frequency information along x and y axes, and neighborhood maxima and minima values.

18. The method of claim 16, wherein computing the motion vector includes performing a phase correlation between the foreground mask of a current image frame and at least one prior image frame.

19. The method of claim 16, further comprising:
performing training of the statistical model in response to either a non-detection of any object in the scanning volume, or the extent of motion of the object being indicative of the object moving in the scanning volume.

20. The method of claim 16, further comprising:
illuminating the scanning volume in response to initial detection of a possible presence of the object in the scanning volume based on a size of the foreground mask.
